(19) United States
(12) Patent Application Publication
(10) Pub. No.: US 2013/0147196 A1
(43) Pub. Date: Jun. 13, 2013

(54) Solar Tower With Integrated Gas Turbine

(71) Applicant: Alstom Technology Ltd., Baden (CH)

(72) Inventor: Kai Wieghardt, Bochum (DE)

(73) Assignee: ALSTOM TECHNOLOGY LTD., Baden (CH)

(21) Appl. No.: 13/758,153

(22) Filed: Feb. 4, 2013

Related U.S. Application Data
(63) Continuation of application No. PCT/EP2011/063532, filed on Aug. 5, 2011.

(30) Foreign Application Priority Data
Aug. 6, 2010 (DE) 102010036900.4

(51) Int. Cl. F03G 6/04; H02K 7/18; F02C 1/10

(52) U.S. Cl. CPC F03G 6/04; F02C 1/10; H02K 7/1823
USPC 290/52; 60/641.12; 60/39.19

(57) ABSTRACT

A solar tower (1) has a solar radiation receiver (4) and a gas turbine engine (2). The gas turbine engine (2) is vertically arranged within the tower and includes, in downward flow series:
a compressor (3) for compressing ambient air (15) drawn through at least one air inlet at an upper end of the tower,
a heating arrangement (4) for heating compressed air from the compressor, the solar radiation receiver includes at least part of the heating arrangement, and
a turbine (5) for extracting work from the heated compressed air.

The gas turbine engine (2) is integrally formed with the solar tower (1) and the gas heating arrangement of the gas turbine engine (2) is integrally formed with the solar radiation receiver (4).

This application is a Continuation of, and claims priority under 35 U.S.C. §120 to, International App. No. PCT/EP2011/063532, filed 5 Aug. 2011, and claims priority therethrough under 35 U.S.C. §§119, 365 to German App. No. 10 2010 036 900.4, filed 6 Aug. 2010, the entireties of which are incorporated by reference herein.

### BACKGROUND

1. Field of Endeavor

The present disclosure relates to concentrated solar power, and in particular to an advantageous combination of a solar power tower with a gas turbine engine to generate electricity.

2. Brief Description of the Related Art

Concentrated solar power involves the use of lenses, mirrors or other optical apparatus to focus solar radiation from a large incident area onto a small area. The energy from the solar radiation is then used to generate power. Concentrated solar power is expected to become an important energy source in the future.

There have been many proposals for concentrated solar power technology. The technology believed to have the most potential for providing high efficiency power generation is central receiver technology. This technology involves the use of a central solar power tower to receive solar radiation that is reflected to be incident upon it by an array of tracking reflectors located in a solar field around the tower.

It is known to use the solar radiation incident upon a solar tower to directly heat water to generate steam for a steam turbine using the Rankine cycle. Electricity is generated for the utility grid by using the steam turbine to drive a generator, which is connected to the electricity grid through a suitable rectifier/inverter combination. Some of the hot steam can be diverted from the turbine and stored for a limited period in insulated tanks to supplement power production during short periods of low insolation.

Some other solar power schemes use the solar radiation incident upon a solar tower to directly heat a molten salt, which is then passed through a heat exchanger to heat water to generate steam for a steam turbine, etc. The molten salt is also used as a heat storage reservoir so that during periods of low or zero insolation, the stored molten salt can still be used to raise steam and produce electricity as required to feed into the utility grid. See, for example, GB 2449181B.

When directly heating either water or molten salt by solar radiation, the energy from the solar radiation is transferred to the fluid using a superficial receiver mounted on the solar tower. In superficial receivers, heat is transferred to the fluid through a pressurized tube wall. As a result, superficial receivers have the same technical limits as boilers. This limits the temperature to which the fluid can be heated to approximately 750° C. and correspondingly limits the maximum efficiency of the solar tower.

In order to overcome the efficiency problems inherent with solar towers utilizing superficial receivers, solar towers utilizing volumetric receivers to heat gas have been proposed. Volumetric receivers are formed such that the solar energy incident upon the solar tower is transmitted to a reticulate porous ceramic, which can be heated up to temperatures of 1500° C. Gas is then heated by passing it through the hot porous ceramic. The heated gas can then be used to heat water and thereby generate power using a steam turbine operating according to the Rankine cycle and/or to generate power using a gas turbine operating according to the Brayton cycle.

Volumetric receivers can be open, wherein the solar radiation is focused directly upon the porous ceramic and gas is drawn into the solar tower and through the porous ceramic directly from the surrounding ambient atmosphere. Alternatively, volumetric receivers can be sealed from the ambient atmosphere and pressurized. In sealed volumetric receivers the porous ceramic is positioned within a sealed volume and the energy from the solar radiation is transferred to the porous ceramic through a window or wall that seals the sealed volume from the surrounding environment. This allows pressure to be maintained within the receiver.

Two currently proposed sealed volumetric receivers are window receivers and cavity receivers. In window receivers, the receiver is sealed by a resilient window that is substantially transparent to the solar radiation. The resilient window seals the volumetric receiver and thereby allows pressure to be maintained within the receiver. The window does not absorb significant amounts of energy from the solar radiation incident upon it. Instead, the solar radiation passes through the window and the energy is absorbed by the porous ceramic inside the receiver. Proposed window materials include quartz glass. Generally, windows for window receivers are shaped to ensure they can withstand the stresses they are put under due to the temperature difference across the window when the window receiver is in use.

In cavity receivers, the receiver is sealed by a solid wall that can absorb the solar radiation incident upon it. The wall seals the volumetric receiver and thereby allows pressure to be maintained within the receiver. In contrast with window receivers, the wall is not transparent to solar radiation and absorbs the energy from the radiation. The energy is transformed to heat within the wall and is then conducted into the porous ceramic that is positioned within the receiver in contact with the wall. Proposed wall materials include silicon carbide. Typically, the wall of a cavity receiver defines a cavity that extends into the volumetric receiver. This allows the surface area of the wall that is contact with the porous ceramic, and thus the heat transfer from the wall to the porous ceramic, to be maximized.

As in GB 2 449 181B, and also in DE 2 939 416C2, it has also been proposed to use gas turbines in conjunction with solar power towers. Solar radiation is used directly or indirectly to heat a gas, which is then passed through the turbine. To increase thermodynamic efficiency, some of the heat from the power tower may also be used to generate steam for a steam turbine, e.g., by recovering heat from the gas turbine exhaust in the manner of a combined cycle installation. Shaft power from both the gas and steam turbines can then drive one or more generators for electricity production.

Solar towers that include volumetric receivers for heating gas and which generate power using a gas turbine operating according to the Brayton cycle, currently present a particular challenge in achieving thermodynamic efficiency. This is because the gas heated in the volumetric solar receiver must be transported in an economical and loss-free manner from the receiver to a gas turbine at a distance from the receiver. Current research on overcoming this problem is focused on the use of ceramic materials for gas pipes and heat exchangers in order to minimize heat loss.

In light of the above, there is a need for a new solar tower design that utilizes a volumetric receiver for heating gas to operate a gas turbine but that minimizes energy loss.

### SUMMARY OF THE DISCLOSURE

One of numerous aspects of the subject matter described herein includes a solar tower that comprises a solar radiation receiver and a gas turbine engine, the gas turbine engine being vertically arranged within the tower and comprising in flow series:
a compressor for compressing ambient air drawn through at least one air inlet at an upper end of the tower,
a heating arrangement for heating compressed air from the compressor, the solar radiation receiver comprises at least part of the heating arrangement, and
a turbine for extracting work from the heated compressed air.

In this arrangement, the gas turbine engine is integrally formed with the solar tower and the gas heating arrangement of the gas turbine engine is integrally formed with the solar radiation receiver.

The described solar tower is advantageous over the prior art as it allows the most compact mounting of the gas turbine engine and the solar energy receiver in the tower and it minimizes energy loss resulting from the transport of heat from the solar energy receiver means to the gas turbine. It does this by integrating the solar energy receiver with the gas heating arrangement of the gas turbine and thereby removing the need to transport the heat from the solar energy receiver to a gas turbine separate from the energy receiver. That is, the heat generated by the solar radiation incident upon the solar tower is utilized directly at the location where it is created, i.e., the solar energy receiver of the solar tower.

The vertical arrangement of the gas turbine also allows its gas heating arrangement and its integral solar energy receiver to be circumferentially symmetric about the solar tower, thereby allowing the maximum amount of solar radiation to be used to heat the compressed air as it flows the short distance from the exit of the compressor to the entry of the turbine.

As will be readily appreciated, in order for a gas turbine engine to operate it is necessary for a gas heating arrangement located between a compressor and a turbine to be sealed from the surrounding environment such that the gas entering the heating arrangement is drawn in only from the compressor and gas leaving the heating arrangement exits only through the turbine. Therefore, it is necessary for the part of the solar energy receiver which transfers heat to the compressed air to be sealed from the surrounding environment. Hence, the solar energy receiver is preferably of the sealed volumetric type, in which a volume of reticulate porous ceramic or other suitable heat absorber material is sealed from the environment by a solid wall of heat absorbing and transmitting material, such as silicon carbide or quartz.

The solar energy receiver may comprise one or more cavity receivers. Alternatively, the solar energy receiver may comprise one or more window receivers.

In a preferred embodiment, the solar energy receiver comprises a circumferentially symmetric solar receiver. That is, the solar energy receiver is circumferentially symmetric about the solar tower, thereby allowing solar radiation to enter the solar energy receiver substantially equally around its circumference. A circumferentially symmetric solar receiver can be formed of one or more window receivers or one or more cavity receivers or any other suitable means of receiving solar radiation.

Conveniently, the gas turbine engine is formed such that the compressor and any associated air inlet are substantially at the upper end of the tower. It may therefore be preferable that the solar tower further comprises a protective roof positioned directly above the upper end of the tower. A suitable protective roof may be formed such that air can still enter the compressor via an air inlet but will prevent rain or debris being drawn into the compressor and thereby damaging the gas turbine engine.

The above described solar tower preferably includes an electrical generator driven by the gas turbine engine, the generator being mounted within the solar tower. The generator may be directly driven by the gas turbine engine. Alternatively, the generator may be indirectly driven by the gas turbine through gearing.

In order to allow air to leave the solar tower after passing through the gas turbine engine, etc., at least one air exhaust may be provided. The air exhaust can be provided at any suitable location, for example at or near the base of the solar tower.

The solar tower may further comprise at least one heat exchanger arranged to extract heat from exhaust gas of the gas turbine engine. The heat extracted from the gas may be used for any suitable purpose apparent to a person skilled in the art. For example, the heat extracted from the gas may be used for steam generation using known combined-cycle technology and materials. Thus, the heat exchanger(s) may be used to raise steam to power at least one steam turbine operating according to the Rankine cycle, the steam turbine(s) being used to directly or indirectly drive a generator, which may be a different generator from that driven by the gas turbine engine.

In order to make best use of the exhaust gases of the gas turbine engine that is integrally formed with the solar tower, such exhaust gases may be utilized to power at least one additional gas turbine, which can directly or indirectly drive a generator. The additional gas turbine(s) may be located after the heat exchanger(s).

Heat storage means may be provided for storing heat extracted from the gas turbine engine exhaust gases. The heat storage means may comprise any heat storage means known to the person skilled in the art, for example insulated storage tanks for storing hot molten salt or other fluids heated by heat exchange with the gas turbine exhaust. Providing suitable energy storage means may allow the solar tower to continue to generate power during periods when the solar radiation incident upon the tower is of reduced intensity, for example, when there is significant cloud cover.

It may be advantageous if the gas turbine engine is capable of supplementary firing. This would allow the gas turbine engine and any associated generator to operate when there is insufficient solar radiation incident upon the solar energy receiving means to efficiently operate the gas turbine engine. This may occur when there is significant cloud cover or at night. In order to be capable of supplementary firing, the gas turbine engine can additionally comprise a combustion chamber located either downstream of the solar radiation receiver, or in parallel with it, so that combustion gases from the combustion chamber do not pass through or otherwise affect the solar receiver. A combustion chamber may be formed in any manner known to the person skilled in the art.

The gas turbine may be comparatively small and light-weight. Preferably, the gas turbine will have a power of 20 MW or less and therefore be capable of utilizing thrust bearing technology from aero engines. In particular, the bearings of the gas turbine may be the well-known combination ball and roller thrust bearings, as currently used in aero engines.

Preferably, the gas turbine will be operated at a higher speed than the frequency of any associated electricity grid. As a result, known rectifier and/or active generator technology may be utilized to allow a generator operated by the gas turbine to be connected to an associated electricity grid. For example, the generator may be connected to the electricity grid through a suitable rectifier/inverter combination.

Further features and advantages of the above-described solar tower arrangement will be apparent from the specific embodiments illustrated in the drawings and described below.

### BRIEF DESCRIPTION OF THE DRAWINGS

Embodiments of the subject solar tower arrangement will now be described, by way of example only, with reference to the accompanying drawings, in which:

FIG. 1 is a schematic drawing of a solar tower according to a preferred embodiment;

FIG. 2 is a cross-section through the solar energy receiving means of the solar tower of FIG. 1; and

FIG. 3 is a close-up view of the upper end of the solar tower of FIG. 1.

### DETAILED DESCRIPTION OF EXEMPLARY EMBODIMENTS

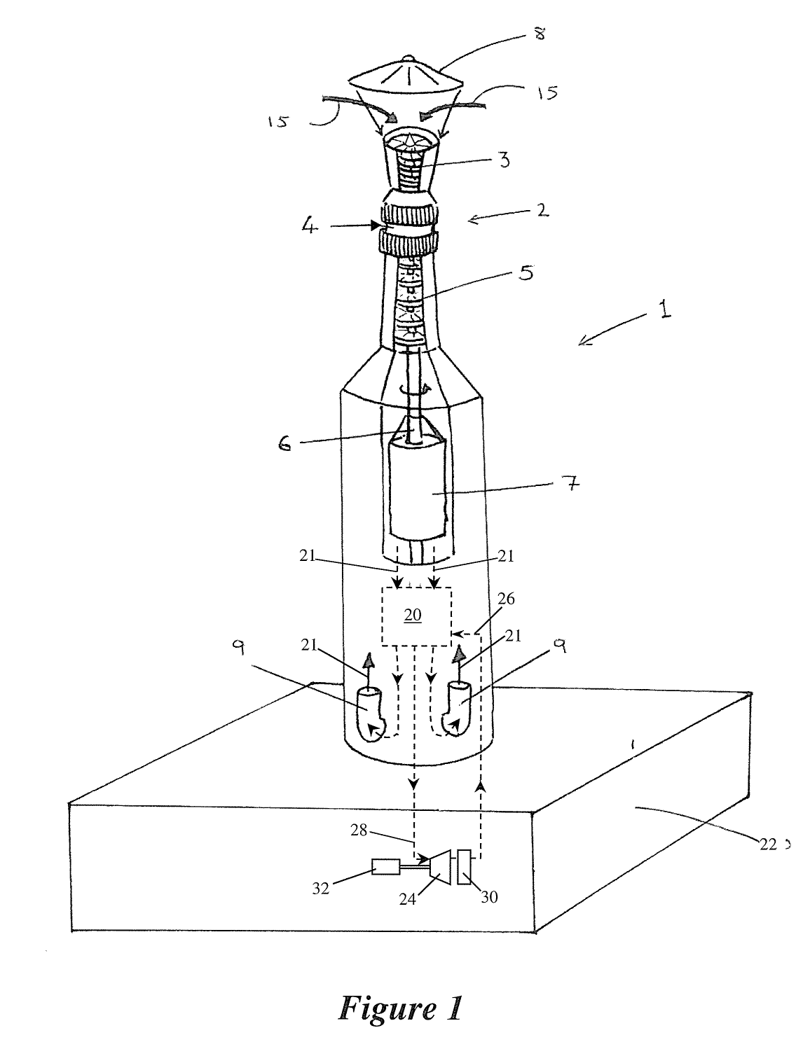

A preferred exemplary embodiment of a solar tower 1 is illustrated in FIG. 1. The solar tower 1 has a gas turbine engine 2 integrally and vertically mounted substantially at an upper end of the tower. The gas turbine engine 2 includes a compressor 3 mounted above a sealed volumetric solar radiation receiver 4, and a turbine 5, mounted below the volumetric receiver. The volumetric receiver 4 forms the gas heating arrangement of the gas turbine engine 2.

The solar tower 1 is located within a solar field (not shown) having a large number of reflectors that act to reflect solar radiation incident upon them onto the sealed volumetric receiver 4.

The compressor 3 and turbine 5 of the gas turbine engine 2 are mounted on a drive shaft 6. The drive shaft 6 extends vertically downwards from the gas turbine engine 2 to drive a generator 7 that is also vertically mounted within the solar tower 1.

A protective roof 8 is mounted above the upper end of the solar tower 1. In FIG. 1 the protective roof 8 is shown a substantial distance above the upper end of the solar tower 1. It is to be understood that this distance is only present to allow the detail of the upper end of the solar tower to be shown more clearly. In practice the protective roof 8 may be mounted closer to the upper end of the solar tower 1. Air is taken into the solar tower at its upper end, as indicated by the arrows 15, compressed, heated and expanded in the gas turbine engine 2 and exhausted from the solar tower 1 through exhaust ducts 9, which in this instance are shown located substantially at its lower end.

In the present embodiment, a heat exchanger 20, shown in dashed lines, is also provided in the solar tower 1 for removing heat from gas 21 that has passed through the gas turbine engine 2. For illustrative convenience, the heat exchanger 20 is shown located near the base of the solar tower, but in practice and as well known in combined cycle plants, it would more likely be located in an exhaust duct of the turbine 5 to receive hot turbine exhaust directly from the turbine 5. However, it would also be possible, though less desirable from the point of view of thermodynamic and aerodynamic efficiency, to locate the heat exchanger 20 outside the solar tower 1, e.g., in a machine hall 22 at the base of the solar tower 1. In that case, the exhaust from the turbine 5 would be ducted into the heat exchanger in the machine hall and be exhausted therefrom, instead of from ducts 9 in the solar tower 1.

The heat removed from the gas is preferably used to power a steam turbine 24 that is contained within the machine hall 22. The steam turbine preferably operates on the Rankine cycle, in which water 26 is input to the heat exchanger 20, heated to produce steam 28, passed through the steam turbine 24 to generate shaft power, condensed back to water in condenser 30 and recirculated to the heat exchanger 20. The shaft power of the steam turbine may be used to drive a generator 32.

One of the problems associated with the use of solar energy is maintaining continuity of power supply during periods of low or zero insolation. To help solve this problem in the solar tower arrangement presented here, three possible strategies are presented, which may be used individually or together in any combination to maintain power supplies.

A first strategy is to provide the gas turbine engine 2 with sequential solar radiation receivers 4A and 4B, which would receive radiation focused onto them from two differently controlled sets of reflectors in the solar field. This might be a useful option to support power production when insolation is less intense, for example during the winter or during periods of hazy sunshine.

A second strategy is to provide the gas turbine engine 2 with a supplementary firing capability, preferably a combustion chamber (not shown) located either after the solar radiation receiver 4, and in flow series with it, or in a flow path arranged in parallel with the flow path through the radiation receiver. Such a combustor could burn, for example, natural gas or hydrogen, and would operate to supplement or replace the heat input from the solar receiver, for example during cloudy periods or at night.

A third strategy is to insert a heat storage capability between the gas turbine engine 2 and the steam turbine cycle. Though not shown in FIGS. 1 to 3, such a heat storage capability is already known from use in connection with solar towers. It would include circulation of a liquid heat storage medium, such as a suitable molten salt, between an insulated storage facility—conveniently provided in the machine hall 22 or in an adjacent underground location—and a multiple circuit heat exchanger arrangement, replacing heat exchanger 20. In this case, heat from the turbine exhaust gases 21 would be transferred to the molten salt as an intermediate heat exchange medium, and the heated molten salt would be used to heat the water for the steam turbine. During periods of low or zero insolation, the steam turbine cycle would continue to provide power due to circulation of molten salt from the storage facility through the heat exchanger arrangement. The period for which power could continue to be provided in such circumstances would depend on the capacity of the heat storage facility.

Even after passing through the heat exchanger 20, there may be sufficient energy remaining in the exhaust gases 21 to make it worthwhile to extract the energy in a low pressure turbine (not shown), which would be placed immediately after the heat exchanger. This could help drive the generator 7, for example.

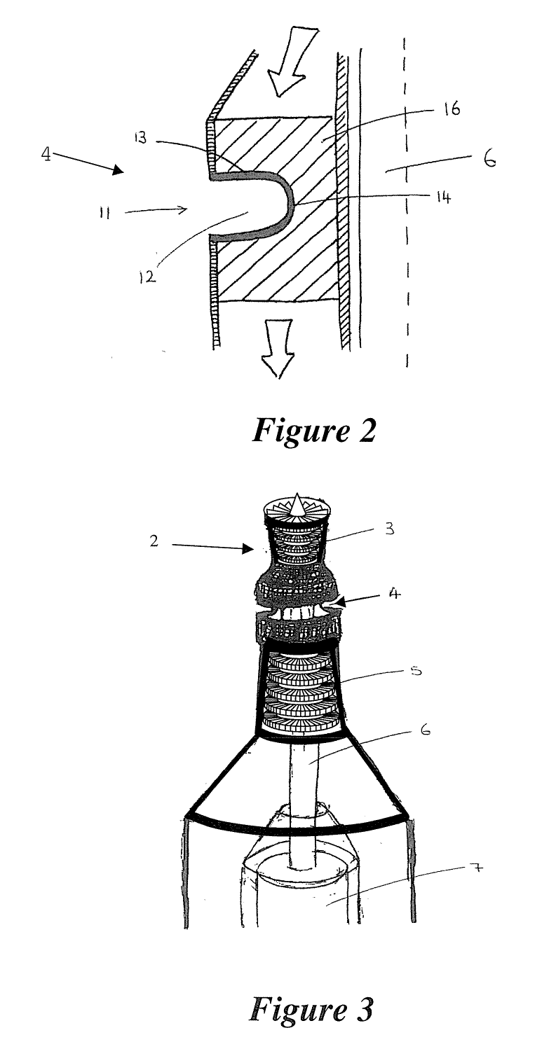

Detail of one possible type of volumetric receiver 4 for solar radiation is shown in FIG. 2. The volumetric receiver 4 includes a plurality of cavity receivers 11 that are mounted around the volumetric receiver in a circumferentially symmetric manner. Each cavity receiver 11 has a cavity 12 extending radially inwards into the volumetric receiver. The cavities 12 have a wall formed of silicon carbide having a cylindrical side portion 13 and a hemi-spherical end portion 14, though the end portion 14 could also have an ellipsoidal or parabolic form. A volume of reticulate porous ceramic 16 is positioned within the volumetric receiver 4 and is in contact with an inner side of the wall of each cavity receiver 11 to act as an absorber of the heat generated in the cavity receiver.

Other types of solar receivers are also being developed. For example, one type uses a quartz window instead of the silicon carbide wall mentioned above, the rear surface of the quartz window being mated with a reticulated ceramic volumetric absorber.

Solar concentrators (not shown) may be used in conjunction with either of the above types of radiation receiver. Solar concentrators, as known, are essentially funnel-shaped internally reflective ducts with relatively wide radiation collection apertures that capture as much as possible of the solar radiation reflected towards the radiation receivers from the solar field. The concentrators taper from their collection apertures down to the dimensions of the entrance apertures of the solar receivers to maximize the amount of solar energy entering the receivers.

The solar tower 1 according to the illustrated embodiment operates in the following manner. The reflectors of the solar field (not shown) are controlled to reflect solar radiation incident upon them onto the volumetric receiver 4 of the solar tower 1. In particular, the solar radiation is directed into the cavities 12 of the volumetric receiver 4. The solar radiation incident upon each cavity 12 heats the cavity wall 13, 14 and that heat is conducted into the reticulate porous ceramic 16 that is in contact with the cavity wall 13, 14. Using silicon carbide for the walls of the cavities 12 and for the reticulated ceramic absorber allows temperatures of up to 1200 degrees Centigrade to be achieved for heating the compressed air that passes through the absorber.

In operation, the compressor 3 of the gas turbine 2 acts to draw air into the gas turbine via the opening at the upper end of the solar tower. The air is compressed to a pressure between 5 bar and 40 bar and enters the volumetric receiver 4. The compressed air passes through the reticulated porous ceramic 16 of the volumetric receiver 4 and in doing so is heated to a temperature of 900° C. or higher. The resulting expansion of the compressed air forces the air out of the lower end of the volumetric receiver 4 and through the turbine 5, thereby driving the rotation of the drive shaft 6. The resulting rotation of the drive shaft 6 powers the compressor 3 and the generator 7.

The exhaust 21 from the turbine 5 remains heated significantly above the ambient temperature and is passed through the heat exchanger 20 to heat water 26, then exhausted via exhaust ducts, such as ducts 9. The water heated in the heat exchanger 20 operates the steam turbine 10 to drive generator 30, as discussed previously.

During normal sustained operation, the gas and steam turbines will preferably rotate at higher rotational frequencies than the electrical grid frequency, meaning that unless suitable reduction gearing is used between the turbines and the generators 7, 30, the generators will also produce electricity at higher than grid frequency. To handle this, the generators may be connected to the grid through a rectifier/inverter combination, as known for variable speed wind turbines.

To protect the turbine blades and other critical components of the gas turbine 2 from the heat generated in the volumetric receiver 4, existing gas turbine cooling technologies can be utilized, as well known to the person skilled in the art.

To minimize top-loading of the solar tower, the gas turbine engine 2 is preferably a relatively light-weight machine, its rotating parts being supported in the vertical position by thrust bearings (not shown) of the type used in aero-engines, usually combination ball and roller bearings, in which rollers take most of the axial loads.

The above embodiments have been described purely by way of example, and modifications can be made within the scope of the appended claims. Thus, their breadth and scope should not be limited by any of the above-described exemplary embodiments. Each feature disclosed in the specification, including the claims and drawings, may be replaced by alternative features serving the same, equivalent or similar purposes, unless expressly stated otherwise. The entirety of each of the aforementioned documents is incorporated by reference herein.

Unless the context clearly requires otherwise, throughout the description, the words “include”, “comprise”, “comprising”, and the like, are to be construed in an inclusive as opposed to an exclusive or exhaustive sense; that is to say, in the sense of “including, but not limited to”.

I claim:

1. A solar tower comprising:
at least one air inlet at an upper end of the tower;
a solar radiation receiver; and
a gas turbine engine, the gas turbine engine being vertically arranged within the tower and comprising, in downward flow series
a compressor configured and arranged to compress ambient air drawn through said at least one air inlet,
a heating arrangement configured and arranged to heat compressed air from the compressor, wherein the solar radiation receiver comprises at least part of the heating arrangement, and
a turbine configured and arranged to extract work from heated compressed air.

2. A solar tower according to claim 1, wherein the solar radiation receiver comprises at least one sealed volumetric solar receiver.

3. A solar tower according to claim 2, wherein the solar radiation receiver comprises at least one cavity receiver.

4. A solar tower according to claim 2, wherein the solar radiation receiver comprises at least one window receiver.

5. A solar tower according to claim 1, wherein the solar radiation receiver comprises a circumferentially symmetric solar receiver.

6. A solar tower according to claim 1, further comprising:
a protective roof positioned above the upper end of the tower.

7. A solar tower according to claim 1, further comprising:
an electrical generator configured and arranged to be driven by the gas turbine engine.

8. A solar tower according to claim 1, further comprising:
at least one exhaust duct for conducting exhaust gases out of the tower.

9. A solar tower according to claim 1, further comprising:
a heat exchanger configured and arranged to extract heat from gas exhausted from the gas turbine engine.

10. A solar tower according to claim 9, further comprising:
a steam turbine configured and arranged to be powered by heat extracted from gas exhausted from the gas turbine engine.

11. A solar tower according to claim 10, further comprising:
an electrical generator;
wherein the steam turbine is connected to drive the electrical generator.

12. A solar tower according to claim 1, further comprising:
heat storage means for storing heat from gas exhausted from the gas turbine engine.

13. A solar tower according to claim 1, wherein the heating arrangement includes supplementary gas turbine firing.

14. A solar tower according to claim 13, wherein the supplementary firing comprises a combustion chamber located either
after the solar radiation receiver and in flow series therewith, or
in a flow path arranged in parallel with a flow path of the compressed air through the radiation receiver.
